(19) United States
(12) Patent Application Publication
(10) Pub. No.: US 2005/0108116 A1
(43) Pub. Date: May 19, 2005

(54) Method and apparatus for allocating items on a bill

(75) Inventors: Matthew Dobson, McAllen, TX (US); Dustin C. Kirkland, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/713,730

(22) Filed: Nov. 13, 2003

(51) Int. Cl. G06F 17/60

(52) U.S. Cl. 705/30

(57) ABSTRACT

A data processing system for settling a bill for items ordered at a restaurant. A set of items for a bill is presented to one or more customers, for which payment is required. User input from one or more customers identifying items from the set of items for payment by a particular person is received to form identified items. Payment is processed for the identified items. The receiving and processing steps are repeated until all items in the set of items for the bill have been identified for payment.

### BACKGROUND OF THE INVENTION

1. Technical Field

The present invention relates generally to an improved data processing system and in particular to a method and apparatus for processing data. Still more particularly, the present invention relates to a method and apparatus for allocating items on a bill for payment.

2. Description of Related Art

In restaurant management, many businesses have implemented computer systems for generating orders and bills. A waitperson typically obtains orders from a party and enters those orders at a terminal. These orders are then transmitted to the appropriate staff to be filled. The waitperson also may generate a bill from the same terminal for presentation to the party at the end of the meal.

Problems and difficulties still frequently arise even with a computerized system. When large groups or parties eat at a restaurant, often times they may wish to settle the bill from multiple accounts. In other words, the large party may wish to have the bill split into multiple bills for payment. Depending on the system, the waitperson may be unable to split or separate the bill into multiple bills. The waitperson may be required to split the bill manually, because such a split is unsupported by the system. The waitperson must then gather up the payment and enter it as a single bill into the system. In some cases, the bill may be split unfairly for some members of a party.

This type of situation is frustrating and bothersome for many consumers on an everyday basis when eating with others at a restaurant. Therefore, it would be advantageous to have an improved method, apparatus, and computer instructions for splitting up items in a bill for payment.

### SUMMARY OF THE INVENTION

The present invention provides a method, apparatus, and computer instructions for settling a bill for items ordered at a restaurant. A set of items for a bill is presented one or more customers, for which payment is required. User input from one or more customers identifying items from the set of items for payment by a particular person is received to form identified items. Payment is processed for the identified items. The receiving and processing steps are repeated until all items in the set of items for the bill have been identified for payment.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of a personal digital assistant in accordance with a preferred embodiment of the present invention;

FIG. 5 is a block diagram illustrating components in settling a bill in accordance with a preferred embodiment of the present invention;

FIGS. 6A-6E are diagrams illustrating screens on a client in accordance with a preferred embodiment of the present invention;

FIG. 7 is a flowchart of a process for ordering items in accordance with a preferred embodiment of the present invention;

FIG. 8 is a flowchart of a process for selecting items for payments in a bill in accordance with a preferred embodiment of the present invention; and

FIG. 9 is a flowchart of a process for handling payment of selected items in accordance with a preferred embodiment of the present invention.

### DETAILED DESCRIPTION OF THE PREFERRED EMBODIMENT

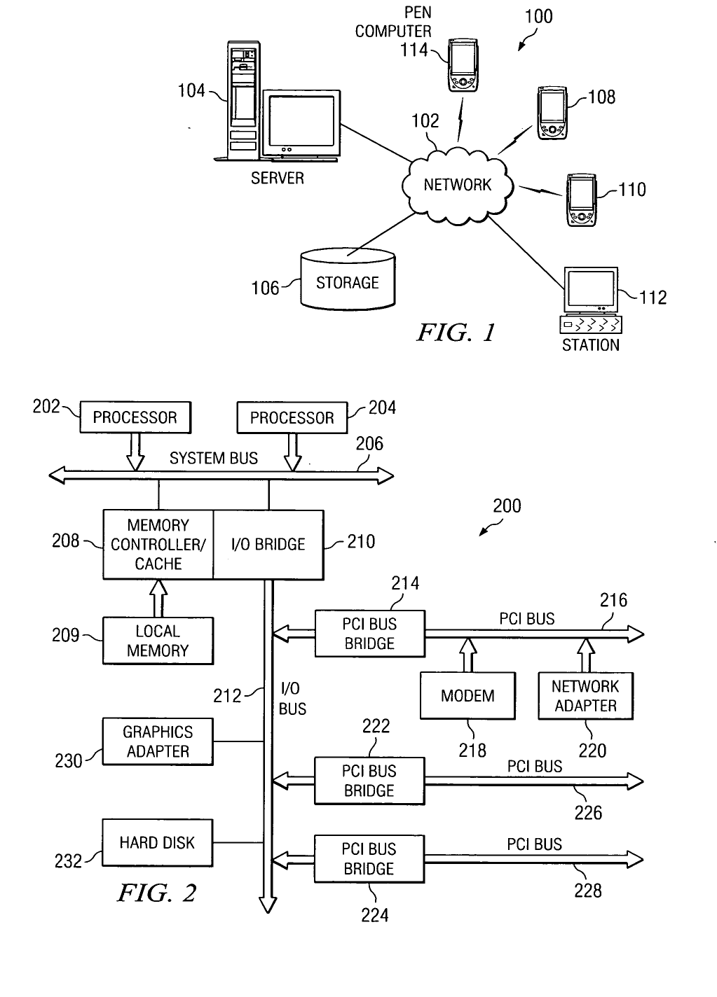

With reference now to the figures, FIG. 1 depicts a pictorial representation of a network of data processing systems in which the present invention may be implemented. Network data processing system 100 is a network of computers in which the present invention may be implemented. Network data processing system 100 is an example of a data processing system that may be implemented for a restaurant in one or more locations. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, 112, and 114 are in communication with network 102. In these examples, clients 108, 110, and 114 are personal digital assistants (PDAs) and a pen based or tablet computer. These clients are used to take orders and provide a portable device for self cashiering or splitting up a bill for a party into multiple accounts. Client 112 is an example of a more traditional terminal used to take orders and generate bills in the restaurant.

In the depicted example, server 104 provides data, such as menu items, costs, and status information as well as boot files, operating system images, and applications to clients 108-114. Clients 108, 110, 112, and 114 are clients to server 104. Network data processing system 100 may include additional servers, clients, and other devices not shown. In the depicted example, network data processing system 100 is a local area network or a wide area network implemented for one or more locations for a restaurant. Of course, network data processing system 100 also may be implemented as a number of different types of networks, such as, for example, an intranet or the Internet. FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

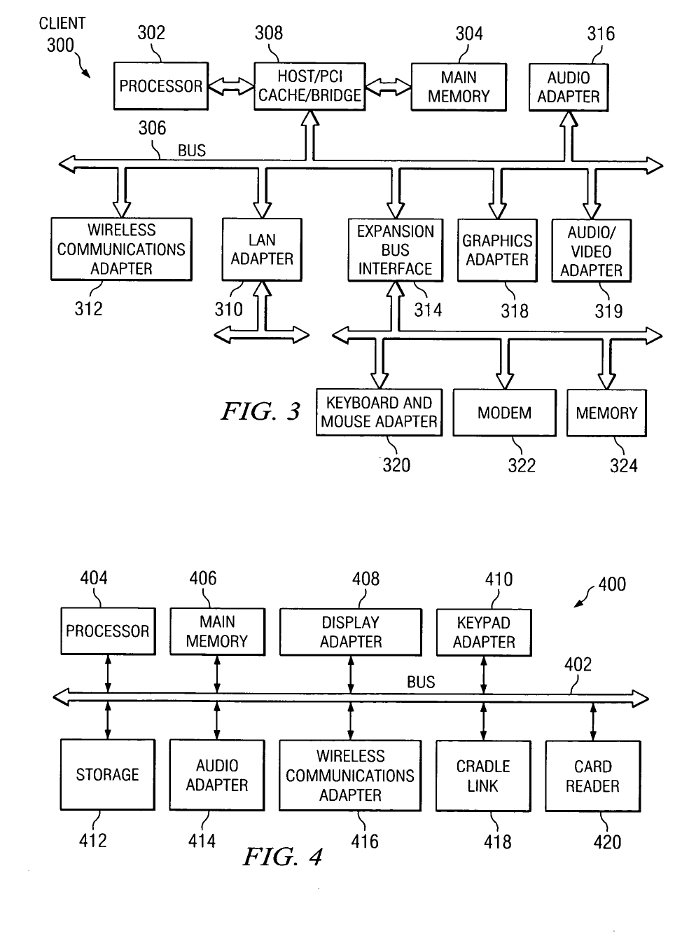

With reference now to FIG. 3, a block diagram illustrating a data processing system is depicted in which the present invention may be implemented. Data processing system 300 is an example of a client computer, such as client 112 or client 114 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, wireless communications adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system. The depicted example in FIG. 3 and above-described examples are not meant to imply architectural limitations.

Turning now to FIG. 4, a block diagram of a PDA is shown in accordance with a preferred embodiment of the present invention. PDA 400 is an example of a PDA, such as client 108 or client 110 in FIG. 1, in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Cradle link 418 provides a mechanism to connect PDA 400 to a cradle used in synchronizing data in PDA 400 with another data processing system. Additionally, PDA 400 also includes wireless communications adapter 416, which is used to establish a communications link with another computer, such as server 104 in FIG. 1. Further, display adapter 408 also includes a mechanism to receive user input from a stylus when a touch screen display is employed.

In these examples, PDA 400 may include an integrated card reader, such as card reader 420. Such a card reader allows for PDA 400 to read information from magnetic strips on debit cards and credit cards. This information is then used to process payment for selected items on a bill.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

Turning now to FIG. 5, a block diagram used in illustrating components in settling a bill is depicted in accordance with a preferred embodiment of the present invention. As illustrated, order process 500 and bill process 502 may be located on a client, such as data processing system 300 in FIG. 3 or PDA 400 in FIG. 4. Server process 504 may be implemented in a server, such as data processing system 200 in FIG. 2. Order process 500 is employed to receive orders 506. These orders are items ordered by a party in these examples. The orders are communicated to server process 504, which handles generating or reproducing orders to be filled.

Additionally, server process 504 also receives information used in payment of bills. This information is received from bill process 502, which allows for a client, such as PDA 400 in FIG. 4 to receive user input, item selection 508, selecting items from a list of purchased items for payment. In this manner, each person at a party is able to select items for which they are responsible.

Bill process 502 also receives payment information 510, which is used to settle the bill. This payment information is passed to server process 504 for processing. In these examples, payment information 510 may be, for example, credit card information, which is obtained by a user sliding a credit card through a card reader in the client. The credit card information may be processed to generate a physical bill for signature.

Alternatively, the customer may authorize payment through a signature generated on the client using a stylus to sign the customer's name on the display. This information may be passed to server process 504 through a wireless link. Also, the information may be passed to server process 504 when the client is placed into a cradle link. In addition, if a customer decides to settle payment for selected items on the bill, an identification of the amount of cash may be entered as the payment information. This type of payment information is processed to indicate how much change is to be returned for a particular account.

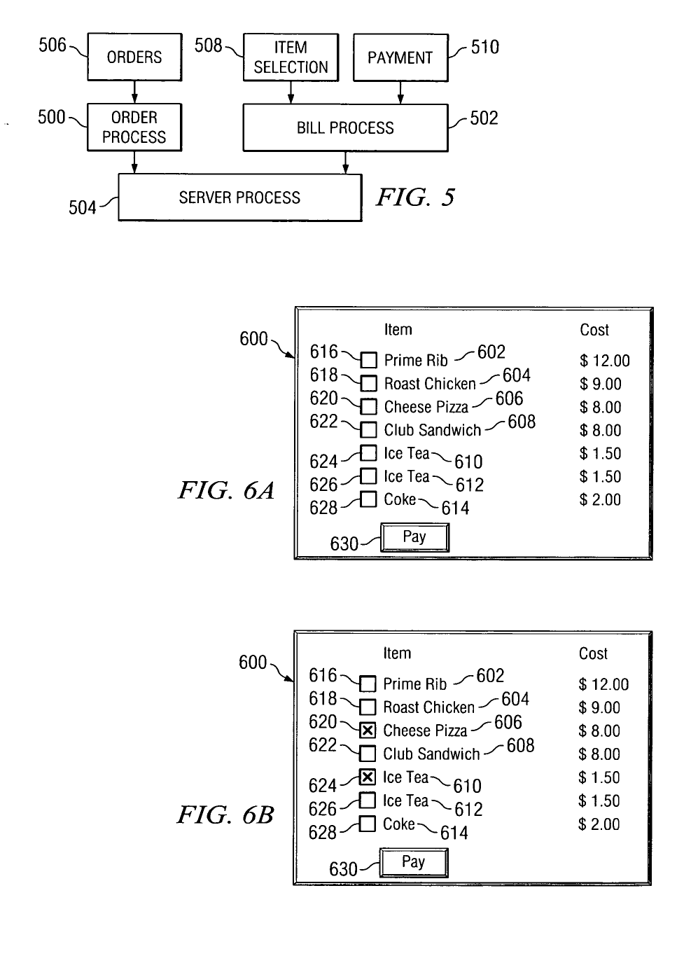

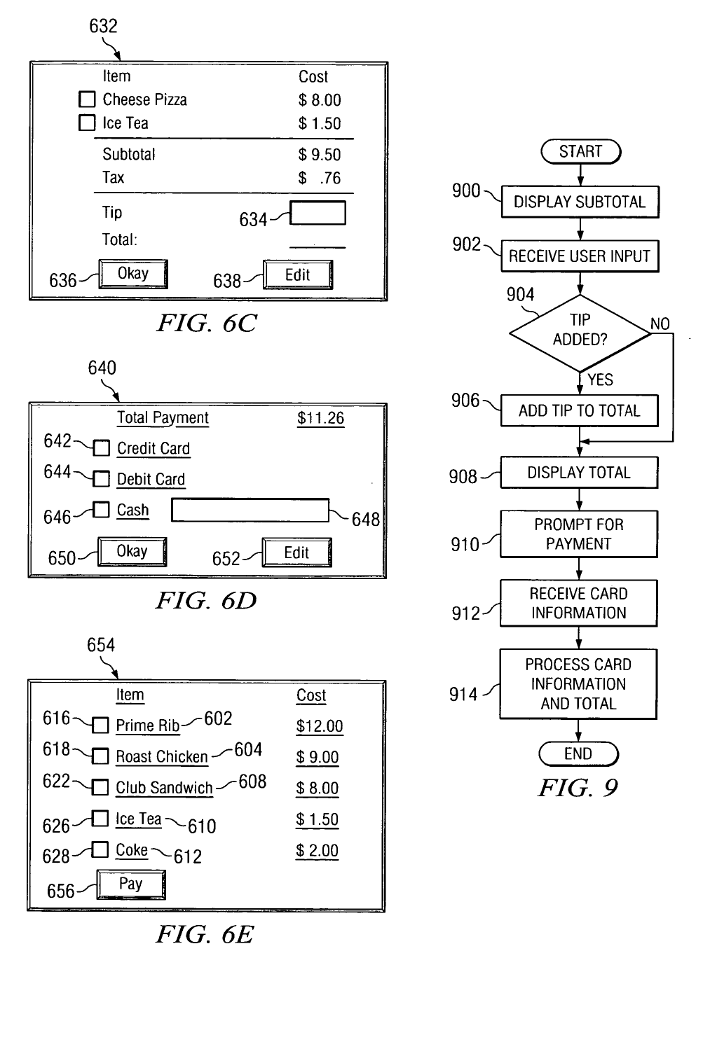

Turning now to FIGS. 6A-6E, diagrams illustrating screens on a client are depicted in accordance with a preferred embodiment of the present invention. The screens illustrated in these figures may be illustrated on a client, such as PDA 400 in FIG. 4.

In FIG. 6A, screen 600 illustrates items 602, 604, 606, 608, 610, 612, and 614 along with checkboxes 616, 618, 620, 622, 624, 626, and 628. A customer may select one or more items for which the customer is responsible for payment by selecting one or more of the checkboxes. When the customer is finished, the customer must select pay button 630. In FIG. 6A, the customer has selected item 606 and item 610 by selecting checkboxes 620 and 624, which now show an “X”. An additional but, such as a “Select All” button may be included to allow for a customer to select all of the items in the list. This might be useful for the last user receiving the device. It also might be useful for a generous patron that decides to pick up the bill for the rest of his lucky friends. Another option that may be included is a “Divide Evenly” button. Selection of this would prompt the user for the number of patrons. Thus, if the total were $76.38 and the table decided to simply divide it evenly by 3 users, then they could select the “Divide Evenly” button, and input “3”. Then, the machine will prompt each of the three users to pay for $25.46.

When pay button 630 is selected, screen 632 is displayed to the customer in FIG. 6C. In this example, the items selected by the customer in FIG. 6B are displayed along with a subtotal and tax. Screen 632, in FIG. 6C, also provides field 634, to allow the customer to enter a tip for the waitperson. A total is then displayed after the tip, if any, is entered. If the customer is satisfied, then the customer then selects “Okay” button 636. If the customer desires to make a change the customer selects “Edit” button 638. Additionally, a suggested tip may be presented to the user. For example, the screen may present amounts for a 15% tip and a 20% tip as suggestions to the customer.

Screen 640 is displayed in FIG. 6D when the user selects “Okay” button 636 from screen 632 in FIG. 6C. In this example, the total payment is illustrated along with check boxes 642, 644, and 646. A customer selects checkbox 642 if a customer is using a credit card to pay for the item. Checkbox 644 is selected when a debit card is used. If the customer decides to pay with cash, checkbox 646 is selected. Additionally, when cash is used, the customer may enter the amount of cash in field 648. If the customer is satisfied with the information entered, the customer may select “Okay” button 650. If the customer decides to make changes, the customer selects “Edit” button 652. When a credit card or debit card is employed, the user may swipe the card through a card reader attached or integrated with the client to facilitate payment. Those screens are not shown in these examples.

In FIG. 6D, if a cash option is selected by checkbox 646, the customer may be presented with an additional screen that asks whether the customer is going to need change for the cash. For example, if a customer indicates that a $17.00 amount is to be paid in cash using a $20 bill, $3.00 in cash will be needed as change. This message may be transmitted to a server to notify waitperson that a customer at a table will need $3.00 in change.

Once the payment has been processed for a particular customer or account, screen 654 in FIG. 6E is displayed. As can be seen, screen 654 only contains entries 602, 604, 608, 612, and 614. Entries 606 and 610 are no longer displayed because those items have been paid. At this point, the customer may pass the client to another customer to continue settling the bill. Depending on the particular implementation, the settled items may remain displayed, but may be displayed in a different form to indicate those items have been paid. Selection of additional entries and “pay” button 656 will start the payment process again for another account.

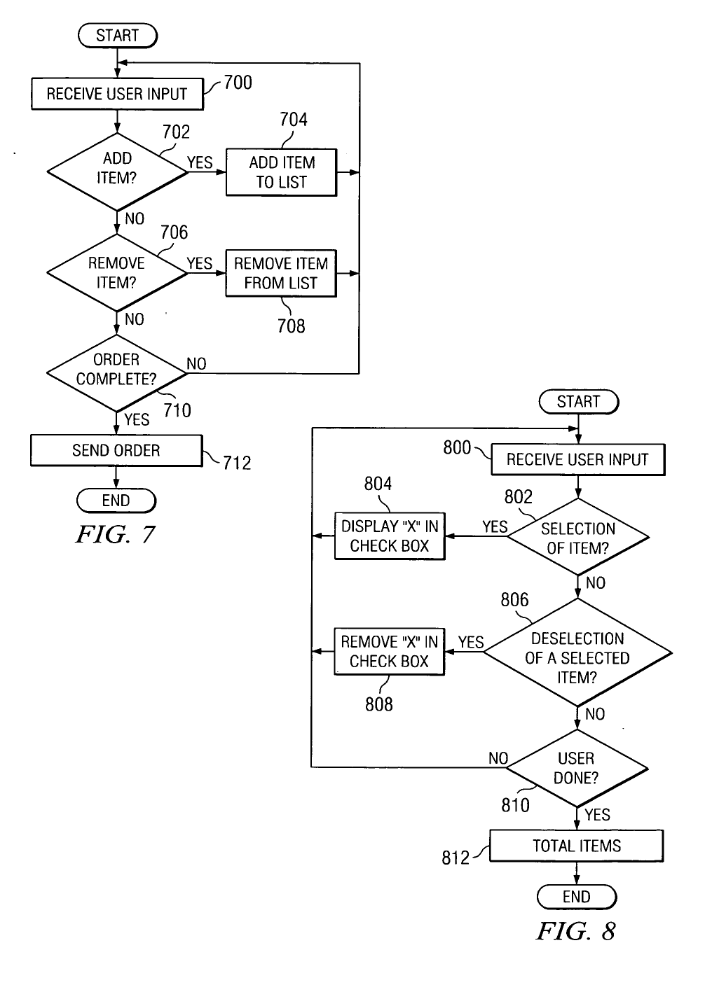

Turning now to FIG. 7, a flowchart of a process for ordering items is depicted in accordance with a preferred embodiment of the present invention. The process illustrated in FIG. 7 may be implemented in a client, such as PDA 400 in FIG. 4.

The process begins by receiving a user input. Then, a determination is made as to whether an item has been added (step 702). If an item has been added by the user input, the item is added to the list (step 704), with the processing returning to step 700 thereafter. In step 702, if an item has not been added, a determination is made as to whether an item has been removed (step 706). If the user input removes an item, the item is removed from the list (step 708), with the process returning to step 700 as described above.

In step 706, if the user input does not remove an item, a determination is made as to whether the order is complete (step 710). If the order is not complete, the process returns to step 700. Otherwise, the order is sent for processing (step 712), with the process terminating thereafter.

In these examples, the user input may be received from either a waitperson or a customer, depending on the particular implementation. If a customer enters the user input, this may be entered as a selection of an item from a list displayed to the customer.

With reference next to FIG. 8, a flowchart of a process for selecting items for payments in a bill is depicted in accordance with a preferred embodiment of the present invention. The process illustrated in FIG. 8, may be implemented in a client, such as PDA 400 in FIG. 4.

The process begins by receiving user input (step 800). This input may be received on the screen of a PDA using a stylus. A determination is made as to whether the user input is a selection of an item (step 802). The item may be an item such as item 606 displayed on screen 600 in FIG. 6A. If the user input is a selection of an item, an “X” is displayed in a checkbox associated with the item (step 804), with the process then returning to step 800 as described above. The checkbox in step 804 may be a checkbox, such as checkbox 620 displayed on screen 600 in FIG. 6B.

In step 802, if the user input is not the selection of an item, a determination is made as to whether the user input is a deselection of a selected item (step 806). If the user input is a deselection of the selected item, the “X” is removed from the checkbox (step 808), with the process then returning to step 800.

If the user input is not a deselection of a selected item in step 806, a determination is made as to whether the user is done selecting items (step 808). This determination may be made by seeing whether a button, such as pay button 630 on screen 600 in FIG. 6A has been selected. If the user is not done, the process returns to step 800. Otherwise, items are totaled (step 812), with the process terminating thereafter.

With reference now to FIG. 9, a flowchart of a process for handling payment of selected items is depicted in accordance with the present invention. The process illustrated in FIG. 9, may be implemented in a client, such as PDA 400 in FIG. 4.

The process begins by displaying a subtotal (step 900). This subtotal may be displayed in a screen, such as screen 632 in FIG. 6C. User input is received (step 902). A determination is made as to whether the user input adds a tip. If a tip is added, this tip is added to the subtotal, with the total then being displayed (step 908). If a tip is not added by user input, the process also proceeds to step 908 as described above.

When the user is done or satisfied with the total, a prompt for payment is made (step 910). This prompt may be made using screen 640 in FIG. 6D. Card information is then received (step 912). This card information may be for either a credit card or a debit card in these examples. The card information and the total amount are then processed to pay for the amount, with the processing terminating thereafter. Although not illustrated in these steps, the payment may also take the form of cash as shown in screen 640 in FIG. 6D.

Thus, the present invention provides a method, apparatus, and computer instructions for splitting a bill. The mechanism of the present invention allows customers to select items for payment. The selected items may be processed for payment with respect to a particular customer. With large groups, multiple accounts may be identified from a single bill. A mechanism of the present invention also provides for receiving card information to pay for selected items. A card reader may be implemented into the device used for splitting the bill. In this manner, the frustrations of attempting to split a bill into multiple accounts for large groups is avoided.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the examples illustrate the processes implemented in a PDA, the processes of the present invention may be implemented in other types of data processing systems, such as, for example, a pen or table PC. Additionally, the devices may contain other components, such as a a built-in printer (laser, dot-matrix, or the like) for actually printing the receipts in the customer's presence for greater efficiency. The embodiment was chosen and described in order to best explain the principles of the invention, the practical application, and to enable others of ordinary skill in the art to understand the invention for various embodiments with various modifications as are suited to the particular use contemplated.

1. A method in a data processing system for settling a bill, the method comprising:
presenting a set of items for a bill for which payment is required;
receiving user input identifying items from the set of items for payment by a particular person to form identified items;
processing payment for the identified items; and
repeating the receiving and processing steps until all items in the set of items have been identified for payment.

2. The method of claim 1, wherein the processing step comprises:
receiving credit card information from the particular person.

3. The method of claim 2, wherein the credit card information is obtained from a magnetic strip on a credit card.

4. The method of claim 1, wherein the data processing system is selected from one of a personal digital assistant or a tablet personal computer.

5. The method of claim 1, wherein the bill is a restaurant bill.

6. The method of claim 1, wherein the data processing system processes the payment by sending payment information to a server data processing system in communication with the data processing system.

7. The method of 6, wherein the data processing system is in communication with the server data processing system using a wireless communications link.

8. A method in a data processing system for processing payment for a plurality of items on a restaurant bill, the data processing system comprising:
presenting the plurality of items on a graphical user interface;
receiving user input, selecting items from the plurality of items on the graphical user interface, to group the plurality of items into a set of accounts; and processing payment of the set of accounts.

9. A data processing system for settling a bill, the data processing system comprising: presenting means for presenting a set of items for a ill for which payment is required; receiving means for receiving user input identifying items from the set of items for payment by a particular person to form identified items;
processing means for processing payment for the identified items; and
repeating means for repeating initiation of the receiving means and processing means until all items in the set of items have been identified for payment.

10. The data processing system of claim 9, wherein the processing means comprises:
means for receiving credit card information from the particular person.

11. The data processing system of claim 10, wherein the credit card information is obtained from a magnetic strip on a credit card.

12. The data processing system of claim 9, wherein the data processing system is selected from one of a personal digital assistant or a tablet personal computer.

13. The data processing system of claim 9, wherein the bill is a restaurant bill.

14. The data processing system of claim 9, wherein the data processing system processes the payment by sending payment information to a server data processing system in communication with the data processing system.

15. The data processing system of 14, wherein the data processing system is in communication with the server data processing system using a wireless communications link.

16. A data processing system for processing payment for a plurality of items on a restaurant bill, the data processing system comprising:
presenting means for presenting the plurality of items on a graphical user interface;
receiving means for receiving user input, selecting items from the plurality of items on the graphical user interface, to group the plurality of items into a set of accounts; and
processing means for processing payment of the set of accounts.

17. A data processing system for settling a bill, the data processing system comprising:
a bus system;
a memory connected to the bus system, wherein the memory includes a set of instructions;
a processing unit connected to the bus system, wherein the processing unit executes the set of instructions to present a set of items for a bill for which payment is required; receive user input identifying items from the set of items for payment by a particular person to form identified items; process payment for the identified items; and repeat the instructions to receive and to process until all items in the set of items have been identified for payment.

18. A data processing system for processing payment for a plurality of items on a restaurant bill, the data processing system comprising:
a bus system;
a memory connected to the bus system, wherein the memory includes a set of instructions;
a processing unit connected to the bus system, wherein the processing unit executes the set of instructions to present the plurality of items on a graphical user interface; receive user input, selecting items from the plurality of items on the graphical user interface, to group the plurality of items into a set of accounts; and process payment of the set of accounts.

19. A computer program product in a computer readable medium for settling a bill, the computer program product comprising:
first instructions for presenting a set of items for a bill for which payment is required;
second instructions for receiving user input identifying items from the set of items for payment by a particular person to form identified items;
third instructions for processing payment for the identified items; and
fourth instructions for repeating initiation of the second instructions and third instructions until all items in the set of items have been identified for payment.

20. A computer program product in a computer readable medium for processing payment for a plurality of items on a restaurant bill, the computer program product comprising:
first instructions for presenting the plurality of items on a graphical user interface;
second instructions for receiving user input, selecting items from the plurality of items on the graphical user interface, to group the plurality of items into a set of accounts; and
third instructions for processing payment of the set of accounts.
